(19) United States
(12) Patent Application Publication
(10) Pub. No.: US 2009/0201234 A1
(43) Pub. Date: Aug. 13, 2009

(54) Active matrix organic light emitting diode display

(75) Inventor: Michael G. Kane, Princeton, NJ (US)

Correspondence Address: HARNESS, DICKEY & PIERCE, P.L.C., P.O. BOX 8910, RESTON, VA, 20195, US

(73) Assignees: Samsung Electronics Co., Ltd.; Sarnoff Corporation

(21) Appl. No.: 12/068,893

(22) Filed: Feb. 13, 2008

(51) Int. Cl. G09G 3/32

(52) U.S. Cl. 345/82

(57) ABSTRACT

Provided is an active matrix light emitting diode (AMOLED) display. A driver circuit of the AMOLED display can be easily manufactured in a simple structure in a current programming method. The AMOLED display programs a voltage corresponding to a current necessary for the operation of an OLED in a memory capacitor, and induces and stores a voltage corresponding to a driving voltage in the memory capacitor while making a preset current flowing between a source and a drain of a driving transistor.

### BACKGROUND OF THE INVENTION

1. Field of the Invention

The present invention relates to an active matrix organic light emitting diode (AMOLED) display, and more particularly, to a current programmed AMOLED display that can be easily manufactured in a simple structure.

2. Description of the Related Art

Conventional active matrix organic light emitting diode (AMOLED) displays have faster response characteristics and wider viewing angles than liquid crystal displays (LCDs). Conventional AMOLED displays include in each pixel an organic light emitting diode (OLED) which emits light when a current is passed through it, and a driver which drives the OLED. The driver basically includes a switching transistor which allows the pixel to be accessed, and a driving transistor which supplies a current to the OLED.

A pixel of an AMOLED display includes a switching transistor (sampling transistor) which samples an analog image signal, a memory capacitor which stores an image signal in the pixel, and a driving transistor which controls a current supplied to an OLED according to a voltage of the image signal stored in the memory capacitor.

Typically, channels of the switching and driving transistors are formed of amorphous silicon or polycrystalline silicon. The switching transistor is a switching device which allows a data voltage to be applied to the driving transistor and thus should have a low leakage current and a fast response characteristic. The driving transistor supplies a current to the OLED and should have high reliability in current supply for a long time.

Polycrystalline silicon has higher mobility and degrades more slowly during operational life than amorphous silicon. Thus, polycrystalline silicon is preferred to amorphous silicon. However, polycrystalline silicon has a disadvantage in terms of an occurrence of a high off-current due to a leakage current through grain boundaries.

Also, another disadvantage of polycrystalline silicon is that polycrystalline silicon has low uniformity and thus is difficult to uniformly operate in each pixel. Self-compensating voltage programmed AMOLED pixels (refer to Sarnoff, SID 98) and self-compensating current programmed AMOLED pixels (REFER TO Sony, SID 01) have been suggested to compensate for such a uniformity disadvantage. Various other compensation methods have also been suggested. However, circuits become complicated due to compensation devices. As a result, a design for manufacturing the AMOLED display is complicated, and the compensation circuits cause new problems. Accordingly, there are demands for developing a driver circuit of a highly reliable display having low leakage, fast response, and a simple structure.

### SUMMARY OF THE INVENTION

The present invention provides an active matrix organic light emitting diode (AMOLED) display that can display a high quality image by effectively preventing a change in pixel brightness according to a threshold voltage shift of a driving transistor.

The present invention also provides an AMOLED display that can increase yield and simplify the structure of a unit pixel by adopting a smaller number of transistors.

According to an exemplary embodiment of the present invention, there is provided an organic light emitting diode (AMOLED) display comprising: an organic light emitting diode; a driving transistor comprising a drain connected to the organic light emitting diode and a source supplied with a driving voltage for the operation of the organic light emitting diode; a memory capacitor connected to a gate and the source of the driving transistor in parallel; a switching transistor comprising a gate and a drain respectively supplied with scan and data signals and a source connected to the gate of the driving transistor; a programming transistor comprising a gate and a drain respectively connected to the gate and the source of the switching transistor, and a source connected to the gate of the driving transistor; and a current controller determining a current flowing through the driving and switching transistors.

According to another exemplary embodiment of the present invention, there is provided an AMOLED display comprising: a plurality of scan lines and a plurality of data lines disposed on an X-Y matrix; an organic light emitting diode provided in each of pixel areas defined by the scan lines and the data lines; and a driver driving the organic light emitting diode in each of the pixel areas, wherein the driver comprises: driving transistor comprising a drain connected to the organic light emitting diode and a source supplied with a driving voltage for the operation of the organic light emitting diode; a memory capacitor connected to a gate and the source of the driving transistor in parallel; a switching transistor comprising a gate and a drain respectively connected to the scan and data lines and a source connected to the gate of the driving transistor; a programming transistor comprising a gate and a drain respectively connected to the gate and the source of the switching transistor, and a source connected to the gate of the driving transistor; and a current controller connected to the data line to determine a current flowing through the driving and switching transistors.

The driving, switching, and programming transistors may include p-channels.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic equivalent circuit diagram of an active matrix organic light emitting diode (AMOLED) display according to an embodiment of the present invention;

FIG. 2 is an equivalent circuit diagram of a unit pixel of the AMOLED display of FIG. 1;

FIGS. 3A and 3B are equivalent circuit diagrams of the unit pixel for illustrating the operation of the AMOLED display of FIG. 1; and

FIGS. 4A and 4B are graphs illustrating results of simulations performed on the performance of the AMOLED display of FIG. 1.

### DETAILED DESCRIPTION OF THE INVENTION

An active matrix organic light emitting diode (AMOLED) display according to an embodiment of the present invention will now be described in detail with reference to the attached drawings.

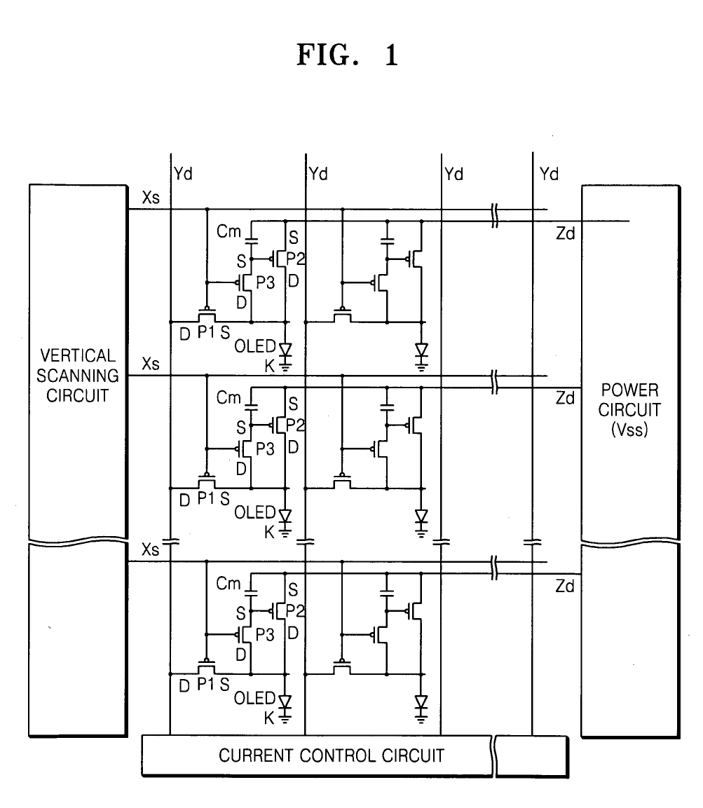

FIG. 1 is a schematic equivalent circuit diagram of an AMOLED display according to an embodiment present invention. Referring to FIG. 1, a plurality of scan lines Xs are orthogonal to a plurality of data lines Yd to form a matrix structure. Power lines Zd are parallel with the scan lines Xs at predetermined distances from the scan lines Xs. Pixels are positioned around intersections between the scan lines Xs and the data lines Yd. Vertical scan signals are applied to the scan lines Xs and data current signals are applied to the data lines Yd. The scan lines Xs are connected to a vertical scanning circuit, and the data lines Yd are connected-to a current controller circuit. The power lines Zd are connected to a power circuit for powering the AMOLED display.

Each pixel includes three p-channel transistors P1, P2, and P3 and one memory capacitor Cm. In each pixel, a gate and a drain of the switching transistor P1 are respectively connected to the scan line Xs and the data line Yd, and a source of the switching transistor P1 is connected to a drain of the driving transistor P2. The memory capacitor Cm stores image data for each pixel and is connected to a gate and a source of the driving transistor P2 in parallel. Ann anode of an OLED is connected to the drain of the driving transistor P2. A cathode K of the OLED corresponds to a common electrode shared by the entire display. A gate of the programming transistor P3 is connected to the scan line Xs and to the gate of the switching transistor P1, and a drain of the programming transistor P3 is connected to the source of the switching transistor P1 and the drain of the driving transistor P2. The transistors P1, P2, and P3 may be organic transistors.

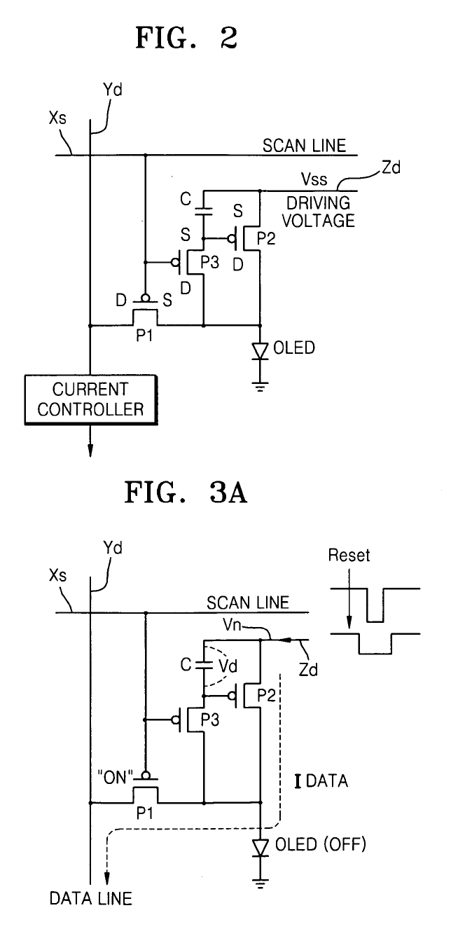

FIG. 2 is an equivalent circuit diagram of a unit pixel of the AMOLED display of FIG. 1.

Referring to FIG. 2, a gate and a drain of the switching transistor P1 are respectively connected to the scan line Xs to which the vertical scan signal is input and the data line Yd to which the data current signal is applied. A gate of the programming transistor P3 is connected to the scan line Xs and to the gate of the switching transistor P1. A source and a drain of the programming transistor P3 are respectively connected to a gate and a drain of the driving transistor P2. An anode of the OLED is connected to the drain of the driving transistor P2 to which a source of the switching transistor P1 is connected. Both ends of the memory capacitor Cm are connected to the gate and a source of the driving transistor P2. A supply voltage Vss is applied to the source of the driving transistor P2 through the power line Zd.

A current controller (a current driving integrated circuit (IC)) as described above is connected to the data line Yd. The current controller determines a current flowing through the driving transistor P2 irrespective of a threshold voltage of the driving transistor P2 to store a voltage corresponding to the current in the memory capacitor Cm.

The operation of the pixel of FIG. 2 will now be described. Easy understanding of the AMOLED display of the present invention can be achieved with understanding of the operation of the pixel.

A pixel circuit of the AMOLED display of the present invention is of a current programmed type having a 3 transistor-1 capacitor (3T-1C) structure including the three P-type transistors P1, P2, and P3 and the memory capacitor Cm.

The amount of a current flowing in the OLED is controlled by the driving transistor P2. The amount of a current flowing in the driving transistor P2 is controlled by a voltage formed at a gate node of the driving transistor P2. A voltage corresponding to a current flowing between the source and the drain of the driving transistor P2 is stored and maintained in the memory capacitor Cm for a frame. A voltage at the both ends of the memory capacitor Cm is automatically generated by a current flowing through the driving transistor P2. In other words, when the driving voltage is turned on, a driving voltage is applied to the source of the driving transistor P2 from the power line Zd, and a current, which is to be flown in the OLED by the current controller connected to the data line Yd, is allowed to flow through the driving transistor. If a predetermined current flows through the driving transistor P2 due to the current controller, a voltage corresponding to the current is automatically induced at the both ends of the memory capacitor Cm. Here, the switching and programming transistors P1 and P3 are turned on due to a scan signal and a data signal. Accordingly, a constant current can flow in the OLED regardless of a characteristic difference caused by the position and the process of a thin film transistor array. Thus, uniform brightness can be achieved.

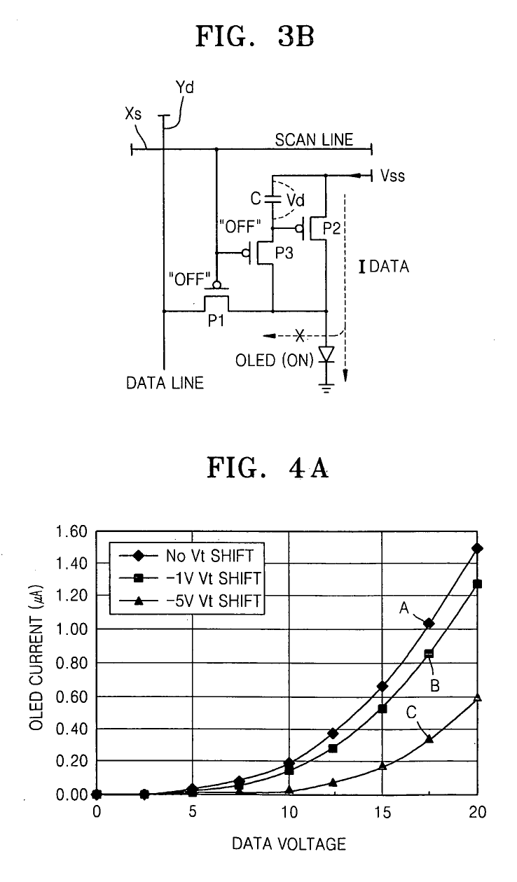

The above-described processes will now be described in phases with reference to FIGS. 3A and 3B.

A. Initially, the switching and programming transistors P1 and P3 are turned off and the driving transistor P2 provides a current to the OLED from a previous frame.

B. A voltage applied to the source node of the driving transistor P2 is switched from the level of a voltage Vss to the level of a lower voltage Vn. Vn is a voltage low enough to turn off the OLED.

C. A current programming step is performed by applying a corresponding signal through the scan and data lines so as to turn on the switching transistor P1 and the programming transistor P3. The programming transistor P3 is turned on, and the driving transistor P2 is also turned on. Accordingly, a programming current Idata flows due to a voltage Vss through the source and the drain of the driving transistor P2 and the source and the drain of the switching transistor P1. Here, the amount of the programming current Idata is determined by the current controller as described above. As a result, a voltage Vd corresponding to the current is induced at the gate and the source of the driving transistor P2, that is, the both ends of the memory capacitor Cm as shown in FIG. 3A.

D. After the corresponding signal applied through the scan line Xs and the data line Yd is blocked to turn off the switching transistor P1 and the programming transistor P3, a driving voltage Vss necessary for the operation of the OLED is applied to the source of the driving transistor P2. Here, a current supplied to the OLED is controlled according to the voltage stored in the memory capacitor Cm. This voltage is induced so as to correspond to a current necessary for the OLED in a programming process. As a result, a desired amount of current is supplied to the OLED as shown in FIG. 3B.

If a method as described above is used, a difference between threshold voltages of the driving transistors can be overcome. Also, uniform programming currents Idata can be supplied to the OLEDs of all pixels. Thus, pixels showing uniform brightness on the entire display can be realized.

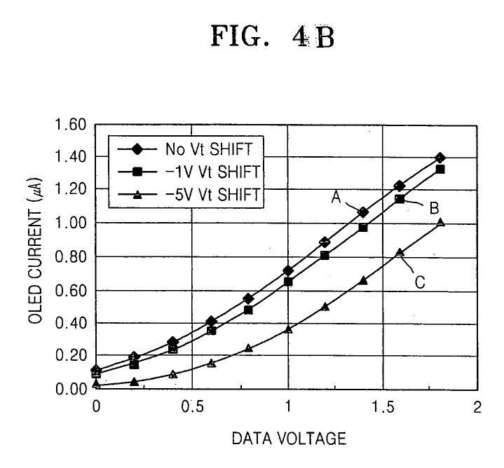

FIGS. 4A and 4B graphs illustrating results of simulations performed on the performance of a unit pixel of the AMOLED display of FIG. 1. FIG. 4A illustrates a relationship between a data voltage and an OLED current. FIG. 4B illustrates a relationship between a data current and the OLED current.

In FIGS. 4A and 4B, “A” indicates a threshold voltage which has not shifted, “B” indicates a threshold voltage which has been shifted by −1 V, and “C” indicates a threshold voltage which has been shifted by −5 V.

According to the results of the simulations, an error of 58% occurs in the shift of the threshold voltage of 5 V in the conventional method. However, an error of only 22% occurs in the present invention.

The present invention can be applied to a display device, particularly, to an AMOLED display using an OLED. The AMOLED display can use an amorphous silicon transistor as an active element.

As described above, in an AMOLED display according to the present invention, a new current programming method can be adopted. Thus, a uniform current can be supplied to OLEDs of all pixels regardless of a difference between the threshold voltages of driving transistors. Thus, an image having uniform brightness can be realized. According to the results of an experiment, a current can be more precisely controlled with respect to a shift of a threshold voltage Vth of a driving transistor than in a conventional method. Such a current programmed display according to the present invention can have a much simpler structure than conventional current programmed self-compensating pixel circuits.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An organic light emitting diode (AMOLED) display comprising:
an organic light emitting diode;
a driving transistor comprising a drain connected to the organic light emitting diode and a source supplied with a driving voltage for the operation of the organic light emitting diode;
a memory capacitor connected to a gate and the source of the driving transistor in parallel;
a switching transistor comprising a gate and a drain respectively supplied with scan and data signals and a source connected to the gate of the driving transistor;
a programming transistor comprising a gate and a drain respectively connected to the gate and the source of the switching transistor, and a source connected to the gate of the driving transistor; and
a current controller determining a current flowing through the driving and switching transistors.

2. The AMOLED display of claim 1, wherein the driving, switching, and programming transistors include p-channels.

3. The AMOLED display of claim 2, wherein the driving, switching, and programming transistors are organic transistors.

4. The AMOLED display of claim 1, wherein the driving, switching, and programming transistors are organic transistors.

5. An AMOLED display comprising:
a plurality of scan lines and a plurality of data lines disposed on an X-Y matrix;
an organic light emitting diode provided in each of pixel areas defined by the scan lines and the data lines; and
a driver driving the organic light emitting diode in each of the pixel areas, wherein the driver comprises:
a driving transistor comprising a drain connected to the organic light emitting diode and a source supplied with a driving voltage for the operation of the organic light emitting diode;
a memory capacitor connected to a gate and the source of the driving transistor in parallel;
a switching transistor comprising a gate and a drain respectively connected to the scan and data lines and a source connected to the gate of the driving transistor;
a programming transistor comprising a gate and a drain respectively connected to the gate and the source of the switching transistor, and a source connected to the gate of the driving transistor; and
a current controller connected to the data line to determine a current flowing through the driving and switching transistors.

6. The AMOLED display of claim 5, wherein the driving, switching, and programming transistors include p-channels.

7. The AMOLED display of claim 5, wherein the driving, switching, and programming transistors are organic transistors.

8. The AMOLED display of claim 4, wherein the driving, switching, and programming transistors are organic transistors.
